(19) United States
(12) Patent Application Publication
(10) Pub. No.: US 2024/0403674 A1
(43) Pub. Date: Dec. 5, 2024

(54) MULTIPLIER TUNING POSTPROCESSING FOR MACHINE LEARNING BIAS MITIGATION

(71) Applicant: Oracle International Corporation, Redwood Shores, CA (US)

(72) Inventors: Mathieu Godbout, Stoneham-et-Tewkesbury (CA); Yasha Pushak, Vancouver (CA); Hesam Fathi Moghadam, Sunnyvale, CA (US); Sungpack Hong, Palo Alto, CA (US); Hassan Chafi, San Mateo, CA (US)

(21) Appl. No.: 18/529,300

(22) Filed: Dec. 5, 2023

Related U.S. Application Data
(60) Provisional application No. 63/470,408, filed on Jun. 1, 2023.

(51) Int. Cl. G06N 7/01; G06N 20/00

(52) U.S. Cl. CPC G06N 7/01; G06N 20/00

(57) ABSTRACT

In an embodiment, a computer infers, from an input (e.g. that represents a person) that contains a value of a sensitive feature that has a plurality of multipliers, a probability of a majority class (i.e. an outcome). Based on the value of the sensitive feature in the input, from the multipliers of the sensitive feature, a multiplier is selected that is specific to both of the sensitive feature and the value of the sensitive feature. The input is classified based on a multiplicative product of the probability of the majority class and the multiplier that is specific to both of the sensitive feature and the value of the sensitive feature. In an embodiment, a black-box bi-objective optimizer generates multipliers on a Pareto frontier from which a user may interactively select a combination of multipliers that provide a best tradeoff between fairness and accuracy.

### CROSS-REFERENCE TO RELATED APPLICATION; BENEFIT CLAIM

This application claims the benefit of Provisional Application 63/470,408, filed Jun. 1, 2023, the entire contents of which are hereby incorporated by reference as if fully set forth herein, under 35 U.S.C. § 119 (e).

### FIELD OF THE INVENTION

The present invention relates to calibration of class probabilities inferred by a machine learning (ML) model. Herein is postprocessing for scaling of respective probabilities of multiple classes based on an input value of a sensitive feature.

### BACKGROUND

Machine learning (ML) models can often be used in applications where their decisions will directly impact people. In these sensitive applications, one must be careful so that the ML models' automated decisions do not disproportionately affect different sub groups of a population. For example, a selection tool should not systematically favor one kind of candidates. While methods have been proposed to mitigate unintended bias present in machine learning models, it remains challenging to train an ML model that satisfies high levels of fairness and accuracy at the same time.

Shortcomings in the state of the art include at least the following.
Use of random selection or random generation to generate or adjust an inference is nondeterministic, which means that an inference might not be repeatable, which may complicate an attempt to explain an inference.
Preprocessing of a training corpus or adjustment inside an ML model may require retraining the ML model, which is slow and may discourage exploration and comparison of solution variations.
Only binary classification between two classes may be supported.
An inferred probability or an inferred score may, by adjustment, become outside a supported range, which alters a classification boundary and will break any predefined threshold such as an anomaly detection threshold.
Lack of configurability may cause acceptance of a suboptimal generated solution, and a generated solution is fragile and may break if requirements or data evolve.

### BRIEF DESCRIPTION OF THE DRAWINGS

In the drawings:

FIG. 1 is a block diagram that depicts an example computer that calibrates probabilities, inferred by a trained classifier, based on postprocessing scaling of respective probabilities of mutually exclusive classes and based on one of multiple values of a sensitive feature;

FIG. 2 is a flow diagram that depicts an example computer process that classifies an input based on postprocessing calibration of inferred probabilities of respective classes;

FIG. 3 is a flow diagram that depicts an example computer process that uses a bi-objective optimizer to optimize multipliers respectively for values of a sensitive feature;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is calibration of class probabilities inferred by a machine learning (ML) model. This entails postprocessing for scaling of respective probabilities of multiple classes based on an input value of a sensitive feature. The scaling uses a multiplier that is bi-objectively optimized to be an excellent tradeoff between fairness and accuracy. This optimization fulfills the following three concerns for producing ML models that are fairer in industrial application settings.

One concern is enforcement of application-specific fairness. While methods have been proposed to mitigate unintended bias present in ML models, it remains challenging to train a ML model that satisfies high levels of fairness and accuracy at the same time. Herein is a more practical approach to producing fair models by discovering a set of models with different fairness-accuracy tradeoffs. This allows an end user to select the model that best matches their specific application's need for fairness and accuracy altogether.

Another concern is being fair and accurate for any metric. There are different ways to measure fairness and accuracy of a given model. Every application has different needs and therefore different relevant metrics to optimize for. The approach herein for increasing a model's fairness is flexible enough to allow any metric to be optimized for. It is possible to optimize any combination of fairness-accuracy metrics.

Another concern is making the model fairer without random assignment. The state of the art may increase a model's fairness by randomly flipping (e.g. reclassifying) some predictions in order to artificially increase or decrease an outcome rate for a protected group. This may be convenient because it simplifies the task of increasing a group's selection rate to picking the percentage of the group's individuals for which predictions should be reclassified to a different label. However, unpredictability of randomness is undesirable behavior in enterprise applications. The approach herein increases a group's selection rate by picking among its individuals that are most likely to have the desired label. For example, to increase the number of some kind of candidates selected in screening decisions, this approach selects the candidates that the ML model already identified as nearest to being selected, instead of randomly sampling from rejected candidates of that kind. Protected groups, sensitive features, and their interrelationship are discussed later herein.

This approach entails multiplier tuning for postprocessing that is straightforward to implement. This approach increases or decreases the majority class's predicted probability by multiplying by different magnitudes for every protected group. The intuition behind this effectively entails using a model's output confidence as a ranking of which individuals should be more likely to have their predicted label corrected. Increasing a protected group's selection rate with respect to a label may entail increasing all of the group's predicted probabilities, which increases the amount in the group that attain that label.

Rather than going through the difficult task of learning different multipliers for every label for each class, multiplier optimization is accelerated by only requiring a multiplier for manipulating the predictions of the majority class, which is the label with the largest number of samples inside the dataset. This design decision of applying a multiplier to the majority class readily extends to multiclass classification, even though existing methods are limited to binary classification (i.e. not multiclass).

Multiplier tuning herein is a multi-objective optimization task that finds postprocessed variations of a model that maximize fairness while minimizing accuracy loss. To this end, there might be no single optimal solution, because some applications may require a perfect fairness criterion while others may find accompanying accuracy loss too prohibitive to reach perfect fairness. Herein, the solution concept for this multi-objective optimization problem is a Pareto frontier that consists of the best found tradeoffs of the two objectives of fairness and accuracy. Here, the best tradeoffs represent models that are not outperformed on both metrics by another model variation found. Intuitively, if model variation A was outperformed on both metrics by a model variation B, there is no reason whatsoever to prefer model A over model B. Therefore, model B may be a Pareto optimal model, but model A would not be. Multi-objective optimization is an inherently challenging endeavor. For straightforward implementation and complete versatility, a best of breed black-box multi-objective optimizer may be used as discussed later herein.

Another complication that can arise when applying multiplier postprocessing is that different trained models have different ranges of probability distributions. Some ML algorithms have a general tendency to remain more cautious in their predictions and always output probabilities within a narrow [0.45, 0.55] range for the majority class. Whereas, other algorithms will cover the [0.0, 0.99] range of probabilities. Discrepant probability ranges expands the search space of multipliers because, in the first case, any multiplier outside the narrow range will change the labels of all the samples, and in the second case a multiplier of ten will not change any labels. The approach herein prunes the multipliers search space to address this range issue, and this pruning accelerates optimization. In the case where the probability range is excessive, a default range of [0.1, 10.0] is used because it corresponds to increasing or decreasing a prediction probability by a maximum of a single order of magnitude.

This approach relies on evaluating numerous different model variations and computing their respective fairness and accuracy scores. For large datasets (100,000+samples), most of the running time of this approach may be spent measuring scores. Randomly sampling from a large dataset to a smaller version that is faster to compute metrics on was experimentally proven to introduce negligible score error when compared to using the entire dataset. A random subsample of 50,000 individuals for datasets larger than that greatly accelerates optimization on massive datasets with no or almost no cost on score precision.

Another problem is what happens when a large number of protected groups (n>5) have to be considered for fairness. In this case, the multipliers' search space is n-dimensional, making the optimization problem much harder. Indeed, black-box optimization has to take into account interactions of the many groups together to optimize for fairness. To compensate, the number of total trials of the tuning algorithm is linearly scaled with the number of groups. This scaling has good performance on applications with a large number of groups and avoids exponential running time complexity.

This approach has at least the following innovations. This is the first fairness postprocessing method to both: a) return a collection of models representing different fairness-accuracy tradeoffs and b) supports any fairness and accuracy metrics combination. A protected group's selection rate is adjusted without using randomness during postprocessing. This method is readily applicable to multiclass classification. This method does not entail a threshold. Adjustment caused by applying one multiplier occurs for all of multiple classes.

This approach has at least the following advantages. It is straightforward to implement. It returns a collection of models for a user to pick from. This allows the user to have the final say in what is the fairness-accuracy tradeoff they prefer for their application. This approach is versatile and can be applied to any machine learning model for binary or multiclass classification to improve any given fairness and accuracy metrics combination. This approach is scalable and only requires a number of operations that is linear with respect to the number of protected groups present in the data. Furthermore, if a validation dataset is available, it does not require training any additional machine learning models because training and retraining is not part of this method.

This approach is deterministic at inference time. Unlike existing bias mitigation postprocessing procedures, this method will always return exactly the same prediction for a given test example, because it does not rely upon random sampling to alter the predictions. This approach returns interpretable probabilities. Other bias mitigation methods directly modify predictions without adjusting the prediction probabilities. This means that the original model prediction probabilities can no longer be interpreted normally. For example, a label that has a prediction probability of 0.99 may in fact not end up being the predicted label with other methods. This also means that any method of scoring the accuracy of a model that relies on prediction probabilities (e.g., log loss, AUC ROC) cannot be used with those methods but can be used herein.

This approach makes business-aligned decisions. That is, the predictions that are changed are those that were closest to having been different in the first place. In a hiring example application, this means that a completely unqualified candidate will not be selected for hiring if there exists a more qualified candidate in the same group. This is not true for existing bias mitigation postprocessing strategies. This approach can be paired with random sampling to accelerate optimization. Users with large datasets can realize large running time speedups with minimal loss in quality by extending this method with random sampling to decrease the size of the dataset, thereby substantially decreasing the cost of computing metrics. For example, the metric computation time was decreased from about 3 hours to about 5 minutes, with only a 2% metric estimation error.

In an embodiment, a computer infers, from an input (e.g. that represents a person) that contains a value of a sensitive feature that has a plurality of multipliers, a probability of a majority class (i.e. an outcome). Based on the value of the sensitive feature in the input, from the multipliers of the sensitive feature, a multiplier is selected that is specific to both of the sensitive feature and the value of the sensitive feature. The input is classified based on a multiplicative product of the probability of the majority class and the multiplier that is specific to both of the sensitive feature and the value of the sensitive feature. In an embodiment, a black-box bi-objective optimizer generates multipliers on a Pareto frontier from which a user may interactively select a combination of multipliers that provide a best tradeoff between fairness and accuracy.

### 1.0 Example Computer

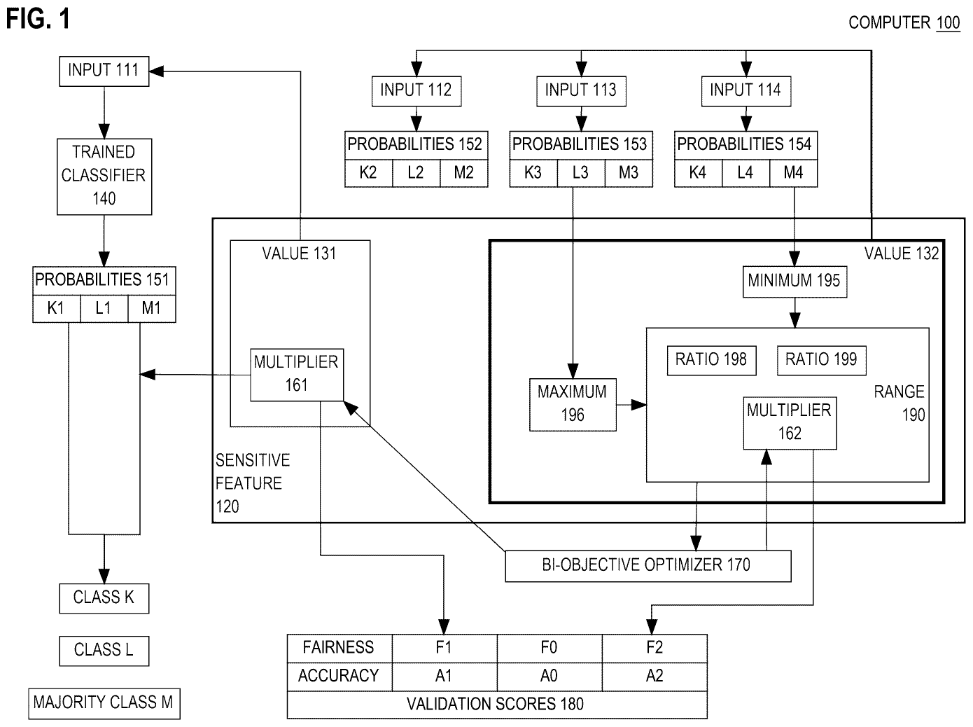

FIG. 1 is a block diagram that depicts an example computer 100, in an embodiment. Computer 100 may be one or more of a rack server such as a blade, a mainframe, a personal computer, or a virtual machine.

Computer 100 calibrates probabilities 151-154 inferred by trained classifier 140 that is a machine learning (ML) model. This calibration is postprocessing for scaling of respective probabilities of mutually exclusive classes K-M based on one of multiple values 131-132 of sensitive feature 120. Sensitive feature 120 deserves special consideration because it is positively or negatively correlated with a protected group of inputs. In an embodiment, each of inputs 111-114 is a feature vector, such as a one-dimensional array of numbers, that represents a record of a subject such as a person.

Each of inputs 111-114 has a respective value of each of multiple features, including sensitive feature 120. Each feature has a respective datatype such as a number, a string, or a data structure, and all of those datatypes can be numerically encoded in a feature vector such as by one-hot encoding or hash encoding. For example, input 111 has value 131 of sensitive feature 120, and inputs 112-114 instead have value 132.

### 1.1 Machine Learning Classifier

In one example, trained classifier 140 is an opaque (i.e. black box) ML model that cannot be retrained by computer 100. For example, the user (not shown) of computer 100 might not know how trained classifier 140 was trained. For example, the user might not know if trained classifier 140's training was supervised or unsupervised.

However, computer 100 is configured to validate trained classifier 140 using a validation corpus that contains inputs 111-114. In an embodiment: validation is supervised; the validation corpus is labeled; and each of inputs 111-114 has a respective label (not shown), which is a known correct classification (i.e. identification of one of classes K-M). For example, input 112 may be labeled as majority class M that is discussed below.

Trained classifier 140 accepts an input (e.g. 111), which causes trained classifier 140 to infer (i.e. generate) a learned inference that contains a respective probability for each of classes K-M. For example, trained classifier 140 infers probabilities 151 from input 111. Probabilities 151 contains probabilities K1, L1, and M1 respectively for classes K-M.

For example for input 111, probability M1 is inferred for majority class M. The state of the art may maximize accuracy by classifying input 111 as majority class M if probability M1 is the highest in probabilities 151. Herein if probability M1 is the highest in probabilities 151, novel multiplier 161 may cause input 111 to instead be classified as any of classes K-M as discussed below. Thus unlike the state of the art, computer 100 classifies input 111 not to strictly maximize accuracy, but instead to maximize fairness or maximize a combination of fairness and accuracy.

### 1.2 Probability Multipliers

As discussed later herein, computer 100 automatically discovers multiple optima that are respective different tradeoffs between fairness and accuracy, and retroactively switching between different tradeoffs does not entail retraining, revalidating, nor otherwise using trained classifier 140. For example, once validation scores 180 are generated as discussed later herein, any of many multipliers 161-162 of sensitive feature 120 may be retroactively applied to recalibrate any inferred probabilities (e.g. 151) without using trained classifier 140. Thus architecturally, recalibration by applying multipliers 161-162 is postprocessing, which is downstream of trained classifier 140. It does not matter if postprocessing occurs immediately after inferring probabilities 151 or deferred until input 111 might need reclassification without using trained classifier 140. In other words, probabilities 151 may be live or archival.

Multiplier 161 achieves recalibration of probabilities 151 as follows. Herein it does not matter if: a) majority class M is whichever class is most frequent in the labeled validation corpus that contains inputs 111-114, or b) majority class M is the class that most frequently has the highest probability in inferences by trained classifier 140.

In one example, probability M1 may be the highest in probabilities 151 until probability M1 is multiplied by multiplier 161 to generate a multiplicative product (not shown). Multiplier 161 is a positive real number that, if less than one, generates a multiplicative product that is less than probability M1. Likewise, multiplier 162 may or may not be greater than one, which generates a multiplicative product that is greater than probability M1. Because the multiplicative product is used during postprocessing herein as a replacement of the originally inferred probability (e.g. M1) of majority class M, the probability of majority class M relative to other classes K-L may be decreased or increased based on which one of multipliers 161-162 is used, which is dynamically selected as follows.

Herein, each of distinct values 131-132 of sensitive feature 120 or, in an embodiment not shown, each distinct disjoint (i.e. nonoverlapping) subset of values of sensitive feature 120, has a respective distinct multiplier. Herein, each distinct value or each distinct subset of values of sensitive feature 120 is referred to as a protected group. Herein, there always are multiple protected groups in sensitive feature 120 and thus multiple multipliers as discussed below. The value of sensitive feature 120 in an input determines which of multipliers 161-162 is selected for that input. For example, multiplier 161 is selected for input 111 that has value 131 for sensitive feature 120. Likewise, multiplier 162 is selected for inputs 112-114 that instead have value 132 for sensitive feature 120.

For example, probability M1 may be the highest in probabilities 151, and multiplier 161 may cause probability M1 to become relatively lower than zero or more of other probabilities K1-L1. For example after applying multiplier 161 to probability M1, probability K1 may become the highest. In that case, input 111 would be classified as class K even though probability M1 was originally higher than probability K1.

In another example, trained classifier 140 infers probabilities 152 from input 112. Because input 112 has value 132 for sensitive feature 120, multiplier 162 is selected for input 112. Probability L2 may be the highest in probabilities 152, and multiplier 162 may cause probability M2 to become relatively higher than zero or more of other probabilities K2-L2. For example after applying multiplier 162 to probability M2, probability M2 may become the highest. In that case, input 112 would be classified as class M even though probability M2 was originally lower than probability K2.

In those ways, a multiplier may more or less immediately cause a live classification to a class of a lower probability. Likewise in those ways after a previous classification of an input, a retroactively applied multiplier may subsequently cause a reclassification of the input to a class of a lower probability.

### 1.3 Multiplier Optimization

The lifecycle of multipliers 161-162 has an optimization phase followed by an application phase. As follows, optimized generation of multipliers 161-162 during the optimization phase may be based on optimization components 170, 180, 190, 195-196, and 198-199 whose sole purpose is to optimize multipliers 161-162 after which those optimization components may be discarded along with the validation corpus, including inputs 111-114 and their respective inferred probabilities 151-154. In other words, deployment for the application phase might entail only production components 140, 161-162, and K-M.

In production, new inputs may occur that were not in the validation corpus and, for example, did not exist during the optimization phase, and trained classifier 140 may infer new probabilities for those new inputs as discussed later herein. During the optimization phase, all of the components shown in FIG. 1 are stored or generated in random access memory (RAM) in computer 100. The application phase may occur on a same or different computer in a same or different environment as the optimization phase.

During the optimization phase, bi-objective optimizer 170 generates many distinct multipliers as candidates for each of multipliers 161-162. In an embodiment, bi-objective optimizer 170 is a multi-objective optimizer into which any amount (e.g. two) of custom objectives may be loaded. In an embodiment, bi-objective optimizer 170 has a respective distinct and independent supervised objective to maximize a respective distinct and independent one of each of two supervised validation metrics that are the accuracy of classifications and the fairness of classifications.

An embodiment may use any of the following classification fairness metrics: Statistical Parity Difference (SPD), Disparate Impact (DI), Equal Opportunity Difference (EOD), Equalized Odds Difference (EOD), Demographic Parity (DP), Conditional Demographic Disparity (CDD), Theil's Information Inequality, Confusion Matrix Disparity (CMD), Consistency Score, and Treatment Equality (TE).

### 1.4 Black Box Optimizer

In an embodiment, bi-objective optimizer 170 is exploratory in an evolutionary (e.g. generational) way. For example, bi-objective optimizer 170 may receive initial validation scores FO and AO that respectively are a fairness score and an accuracy score as shown in supervised validation scores 180. In an embodiment, bi-objective optimizer 170 is a multi-objective evolutionary algorithm (MOEA) such as a fast and elitist multi-objective genetic algorithm such as non-dominated sorting genetic algorithm II (NSGA-II) that has a python implementation that is open source.

Initial validation scores FO and AO are based directly on original probabilities as inferred by trained model 140 during supervised validation and not based on multipliers. Validation not based on multipliers is logically the same as validation based on identity multipliers whose values are one. In that way, every validation is associated with its own distinct plurality of multipliers, which is one multiplier for each of multiple distinct protected groups as discussed above. For example as shown, there may be two multipliers 161-162 respectively for two groups that each consists of one value 131 or 132. Herein, a validation is defined by its distinct plurality of multipliers.

### 1.5 Validation Measurements

Herein, multi-objective validation has multiple objectives (e.g. metrics). Herein, bi-objective validation has a classification fairness metric and a classification accuracy metric. Herein, accuracy may generally be any model fitness metric. For example, many distinct fitness metrics are based solely on a confusion matrix or not based on a confusion matrix. Herein, a validation has a separate validation score demonstratively shown in a respective row of validation scores 180 for each validation metric. As shown, validation scores 180 has two rows for two validation metrics that are classification fairness and classification accuracy. As shown, validation scores 180 has three columns for three validations, with the center column for the initial validation without multipliers.

In an embodiment, a validation (i.e. its distinct plurality of multipliers) is generated by computer 100 or by bi-objective optimizer 170. In an embodiment, bi-objective optimizer 170 generates every validation except the initial validation that lacks multipliers, which computer 100 generates. Each generated validation is evaluated by computer 100 to generate respective (e.g. two) validation scores.

### 1.6 Optimizer Integration

In an embodiment, bi-objective optimizer 170 may receive the validation scores of a validation from computer 100. For example, computer 100 may receive the distinct plurality of multipliers of a new validation from bi-objective optimizer 170, and computer 100 may evaluate the new validation and provide the validation scores of the validation back to bi-objective optimizer 170. In that way, bi-objective optimizer 170 may greedily or randomly (or a hybrid of both) explore and optimize in a multidimensional problem space that has a distinct dimension for each distinct protected group in sensitive feature 120.

Each distinct validation (i.e. distinct plurality of multipliers, i.e. distinct column in validation scores 180) is a distinct point in that multidimensional problem space. With the addition of (e.g. two) dimensions respectively for two validation metrics (e.g. fairness and accuracy), the multidimensional problem space becomes a multidimensional solution space in which each point has multiple multipliers and multiple validation scores, and bi-objective optimizer 170 explores that multidimensional solution space.

### 1.7 Pareto Frontier

In an embodiment, bi-objective optimizer 170 may retain multidimensional solution points (i.e. multipliers and validation scores) of some (e.g. best scoring) or all validations. For example, bi-objective optimizer 170 may retain some or all of validation scores 180 and may, for example, generate a sequence of validations with increasing validation scores. For example, bi-objective optimizer 170 may select and retain a Pareto frontier that contains only non-dominated multidimensional solution points that are the best validations and thus have the best multipliers. A dominated solution point is dominated by any point whose validation scores equal or exceed the scores of the dominated solution point, so long as at least one score is lower in the dominated solution point. A Pareto frontier contains at least one solution point or, without limit, more. In an embodiment, bi-objective optimizer 170 does not provide a Pareto frontier to computer 100 until every generated point is validated (i.e. scored).

### 1.8 Optimization Pruning

How many points should bi-objective optimizer 170 generate is implementation specific. In an embodiment, a count of points to generate is decided before bi-objective optimizer 170 operates. For example, the count of points to generate may be a multiplicative product of a predefined positive magnitude times a count of distinct protected groups (e.g. distinct values) of sensitive feature 120 in the validation corpus as discussed earlier herein.

In an embodiment, computer 100 initializes bi-objective optimizer 170 with constraints that are range limits on generation of multipliers. For example from computer 100, bi-objective optimizer 170 may receive range 190 for multiplier 162, and bi-objective optimizer 170 only generates values for multiplier 162 that are within range 190. In an embodiment, range 190 is continuous inclusively between: a) a lower bound that is ratio 198 that is positive and less than one and b) an upper bound that is ratio 199 that is greater than one.

In an embodiment: a) ratio 198 is minimum 195 divided by maximum 196; b) ratio 199 is maximum 196 divided by minimum 195, which is the inverse of ratio 198; and c) extreme probabilities 195-196 are probabilities ranging from zero to one. As shown, all of components 162, 190, 195-196, and 198-199 are dedicated to value 132 and, although not shown, value 131 may have similar components. For example from computer 100, bi-objective optimizer 170 may receive a respective range limit for each distinct group (e.g. each distinct value 131-132), and bi-objective optimizer 170 will generate multipliers within those respective ranges.

Extreme probabilities 195-196 are based solely on inferred probabilities 152-154 of inputs 112-114 that have value 132 for sensitive feature 120. In an embodiment, extreme probabilities 195-196 are selected without considering which of class(s) K-M are involved. Extreme probabilities 195-196 may be inferred for a same or different class, and none, one, or both of extreme probabilities 195-196 may or may not be for majority class M. As shown, minimum 195 is probability M4 that is the lowest of inferred probabilities K2-K4, L2-L4, and M2-M4. Likewise, maximum 196 is probability L3 that is the highest of inferred probabilities K2-K4, L2-L4, and M2-M4. The more numerically similar are extreme probabilities 195-196, the narrower is probability range 190, which accelerates bi-objective optimizer 170 by pruning the multidimensional search space. The narrower the probability range limits for values 131-132, the more optimal is the Pareto front generated by bi-objective optimizer 170. Thus, novel range 190 increases speed and accuracy of computer 100.

### 2.0 Example Classification Calibration Process

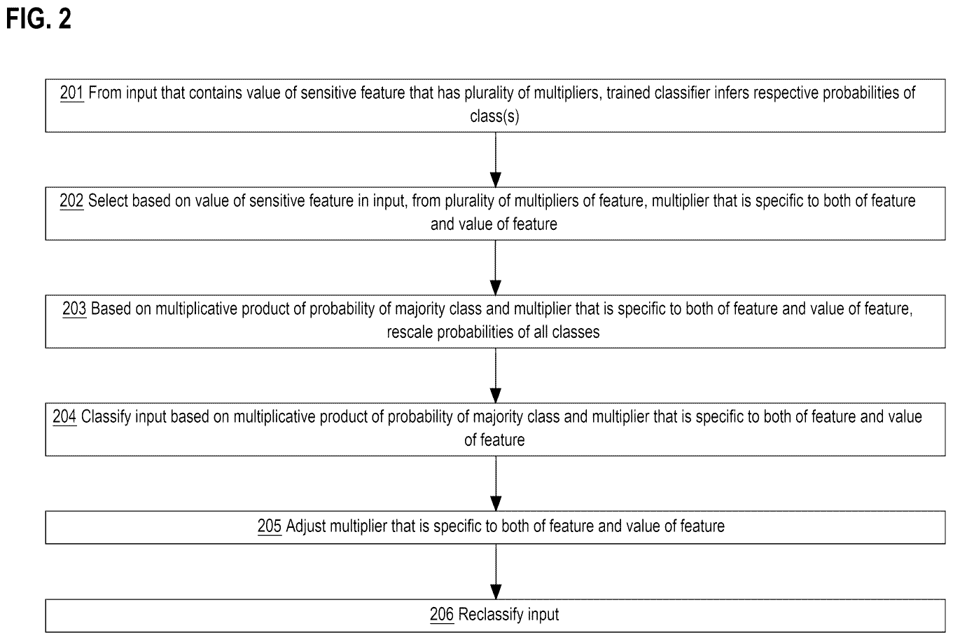

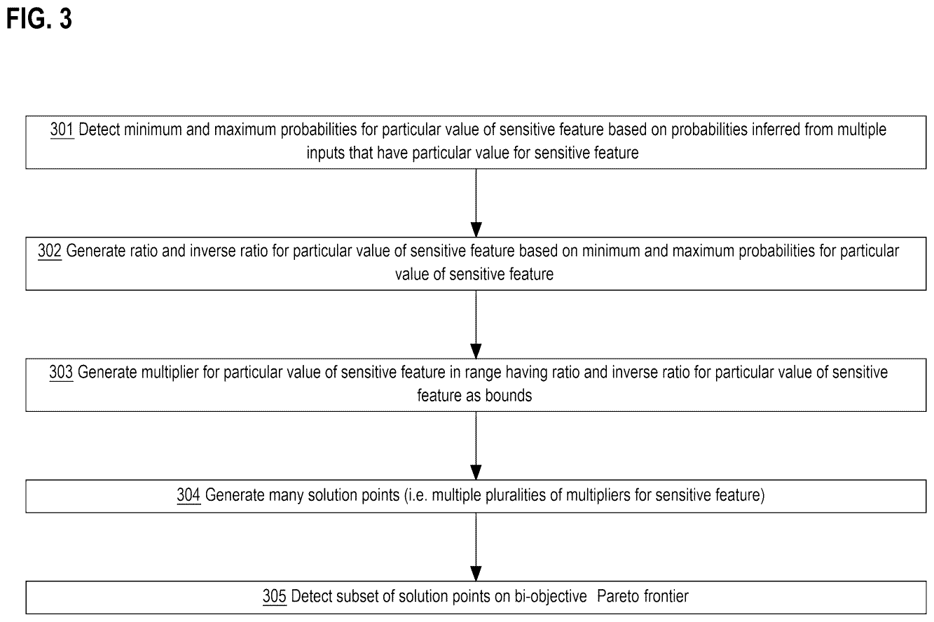

As discussed earlier herein, the lifecycle of multipliers 161-162 has an optimization phase followed by an application phase. FIG. 2 depicts the application phase, and FIG. 3 depicts the optimization phase.

FIG. 2 is a flow diagram that depicts an example process that computer 100 may perform to classify input 111 based on postprocessing calibration of inferred probabilities K1, L1, and M1 respectively for classes K-M. This process presumes that ML model 120 already was trained and that the optimization phase already generated multipliers 161-162.

In this example, input 111 is new (i.e. was not in the validation corpus used by the optimization phase). For example, input 111 might not have existed during the optimization phase. From input 111 that contains value 131 of sensitive feature 120, trained classifier 140 infers probabilities K1, L1, and M1 respectively for classes K-M in step 201. In a binary classification embodiment, there are only two classes K and M and trained classifier 140 infers only one probability K1 for class K, which can be subtracted from one to calculate probability M1 for majority class M.

Herein, there are two distinct kinds of classification, and both are supported by the approaches herein. Binary classification has only two classes from which one class is predicted. Multiclass classification instead has more than two classes from which one class is predicted. Herein, classification and prediction may be synonyms. Herein multiclass means three or more classes. Herein, two classes is not multiclass.

Herein, multiclass is not multilabel. Multiclass entails mutually exclusive classes. Multilabel lacks mutual exclusion.

Recalibration herein entails postprocessing, which is some or all of the following activities and steps that occur after step 201. Based on value 131 of sensitive feature 120 in input 111, from multipliers 161-162 of sensitive feature 120, step 202 selects multiplier 161 that is specific to both of components 120 and 131.

FIG. 1 shows an exemplary embodiment that has: a) a sensitive feature with multiple protected groups (i.e. values 131-132), b) respectively for the protected groups, multipliers 161-162, and c) the multipliers are multiplied only with probabilities of majority class M. However, techniques herein have several variations of which FIG. 1 is only one. The following embodiments are additional variations as discussed later herein. In an embodiment: there is no sensitive feature, feature 120 is not sensitive, and there may be as few as only one multiplier, which is not specific to values 131-132 nor to feature 120. For example, in one embodiment measuring fairness scores F0-F2 may not involve feature 120 or, in an embodiment not shown in FIG. 1, bi-objective optimizer 170 does not use fairness scores F0-F2 and instead uses an additional validation metric. For example, validation scores 180 may have two distinct fitness metrics instead of one fitness metric and one fairness metric as shown in FIG. 1. Step 201 is implemented only if feature 120 is a sensitive feature.

In an embodiment, bi-objective optimizer 170 generates a separate multiplier respectively for each of multiple classes, but not all classes. Those multiple classes may or may not include majority class M. For example, there may be respective multipliers only for a few most frequent classes. In that case, classes L-M may be the top two most frequent classes and have respective multipliers, and only minority class K has no multiplier. A sensitive feature, metrics, and amounts of multipliers are design choices further contrasted as follows.

Between steps 202-203, computer 100 calculates a multiplicative product of probability M1 of majority class M and multiplier 161. This multiplicative product is referred to herein as the multiplied majority probability or, for input 111, multiplied probability M1. That is, from input 111 are generated original probability M1 and, from that, multiplied probability M1. If an embodiment has a respective multiplier for each of multiple classes as discussed above, then there are multiple multiplicative products calculated for one inference, and step 203 uses all of those products. For the embodiment in FIG. 1, step 203 uses multiplied probability M1 instead of original probability M1.

Based on multiplied probability M1 that is based on multiplier 161, step 203 rescales probabilities 151 of all classes K-M. Rescaling by step 203 entails unit normalizing unscaled probabilities 151 that do not sum to one (because multiplied probability M1 is used), which generates rescaled probabilities 151 that sum to one without changing the relative probabilities of classes K-M. For example, if unscaled probability K1 is twice as big as unscaled probability L1, then rescaled probability K1 still is twice as big as rescaled probability L1.

If rescaled multiplied probability M1 is the highest rescaled probability in probabilities 151, then step 204 classifies input 111 as majority class M. Otherwise rescaled probability K1 or L1 is highest. In a multiclass (i.e. at least three classes K-M, i.e. not binary classification) embodiment, the ordering of steps 203-204 may be reversed, and classification by step 204 may compare probabilities that are unscaled instead of rescaled. Thus in some embodiments, rescaling step 203 may be optional (e.g. unimplemented). For example, normalization by rescaling step 203 may increase human interpretability. In an embodiment not shown in FIG. 1, trained machine learning model 140 is not a classifier and may instead be a regression model. In that case, step 203 is unimplemented.

Steps 205-206 are optional and demonstrate a scenario in which reclassification does not entail retraining classifier 140, nor revalidation, nor inferencing by classifier 140, nor any other use of trained classifier 140. Steps 205-206 can retroactively reclassify input 111 even if trained classifier 140 is no longer available. Step 205 adjusts one, some, or all of multipliers 161-162. As discussed earlier and later herein, bi-objective optimizer 170 generates a bi-objective Pareto frontier that may contain multiple non-dominated solution points. Whether one solution point or another is better (i.e. more optimal) depends on the application. For example, which is the best single solution point in the Pareto frontier may be a subjective determination and/or may be changed. For example, the Pareto frontier may contain non-dominated solution points X-Y (not shown). Point X may be selected as best and used by step 202. Step 205 may, for example, replace non-dominated point X with non-dominated point Y as the revised best solution point. This may or may not cause step 206 to reclassify input 111 from class K to either of classes L-M.

### 2.1 Future Proofing

Thus, classification can be recalibrated for classifying new inputs or reclassifying old inputs without retraining classifier 140, and reclassification of old inputs occurs without using trained classifier 140 at all. Recalibration effectively future proofs (i.e. avoids retraining) classifier 140 as follows. Trained classifier 140 may be needed only to infer original probabilities for new input(s). Reclassification of an old input using a different point in an old Pareto front occurs without using trained classifier 140 at all, without re-optimizing, and without using bi-objective optimizer 170.

If at least one validation objective (i.e. validation metric) is replaced, re-optimization by bi-objective optimizer 170 with an old validation corpus may generate a new Pareto front that contains new solution points. However, all of originally inferred probabilities 151-154 are reused for validation of the new solution points, which means that re-optimization with the old validation corpus does not use trained classifier 140. Even replacing bi-objective optimizer 170 with a different bi-objective optimizer and then re-optimizing with the old validation corpus does not use trained classifier 140. In those ways, trained classifier 140 is future proofed for validation metrics that do not yet exist and future proofed for bi-objective optimizers that do not yet exist.

### 3.0 Example Optimization Process

As discussed earlier herein, the lifecycle of multipliers 161-162 has an optimization phase followed by an application phase. FIG. 3 depicts the optimization phase. FIG. 3 is a flow diagram that depicts an example process that computer 100 may perform with bi-objective optimizer 170 to optimize multipliers 161-162 respectively for values 131-132 of sensitive feature 120.

In an embodiment, the optimization phase entails a pruning phase that entails steps 301-302 followed by an exploration phase that entails steps 303-305. Only the exploration phase uses bi-objective optimizer 170. The accuracy and speed of the exploration phase are increased by the pruning phase. Other embodiments may have other pruning steps instead of steps 301-302.

Based only on probabilities 152-154 inferred from inputs 112-114 that have value 132 for sensitive feature 120, step 301 detects extreme probabilities 195-196 for value 132 of sensitive feature 120 as discussed earlier herein.

Based on extreme probabilities 195-196 for value 132 of sensitive feature 120, step 302 generates ratios 198-199 for value 132 of sensitive feature 120 as discussed earlier herein.

Step 303 is a sub-step of step 304. In step 303, bi-objective optimizer 170 generates many candidate multipliers for value 132 of sensitive feature 120 in range 190 that is inclusively bounded by ratios 198-199 as discussed earlier herein.

In step 304 that includes sub-step 303, bi-objective optimizer 170 generates many solution points (i.e. multiple pluralities of multipliers for values 131-132 of sensitive feature 120) as discussed earlier herein.

In step 305, bi-objective optimizer 170 detects the subset of generated solution points that are on a bi-objective Pareto frontier and returns that subset to computer 100. In an embodiment, computer 100 displays the Pareto frontier as a curve in a graph whose two axes respectively are accuracy and fairness. Generated solution points that are part of the Pareto frontier are plotted on the curve based on their validation scores. Thus, a user may perceive the curve as a spectrum of non-dominated tradeoffs between accuracy and fairness, where the opposite poles of the spectrum respectively maximize accuracy or fairness, and all points on the curve between both poles are optimal and distinct compromises. For example, the user may interactively select (e.g. click or hover) a non-dominated solution point on the curve (i.e. the Pareto frontier) to cause computer 100 to display the details of that validation, including the distinct plurality of multipliers for sensitive feature 120 and both validation scores. Thus, the user may interactively explore the Pareto frontier that was automatically generated by bi-objective optimizer 170 and may, for example, discover a particular non-dominated solution point that (e.g. subjectively) seems best.

In an embodiment, computer 100 automatically preselects one generated solution point on the Pareto frontier as a default best solution point. For example, computer 100 may select the generated solution point that has a highest fairness or accuracy or highest (e.g. weighted) sum of fairness and accuracy scores.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

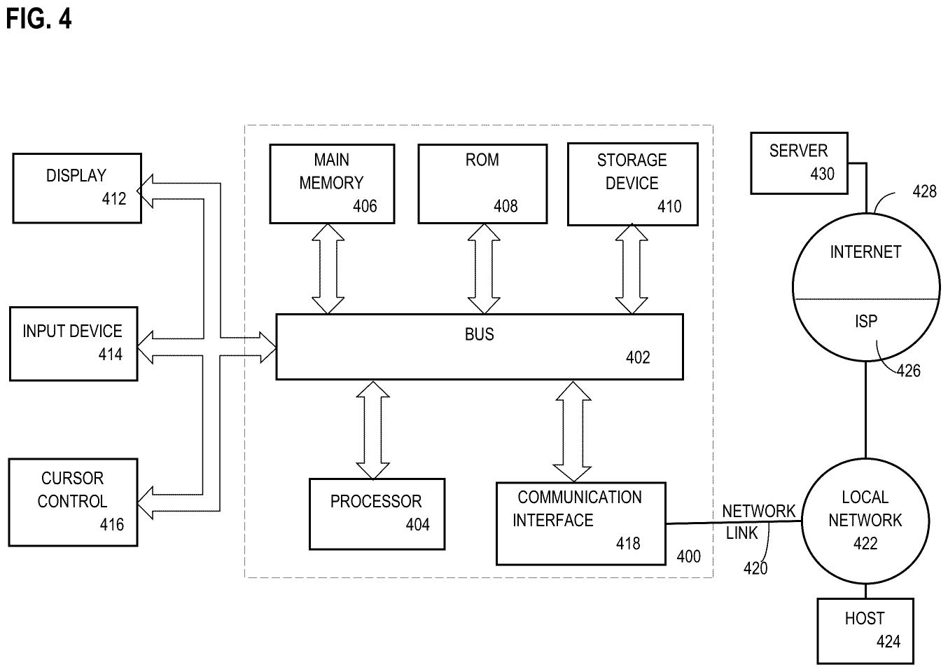

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Over View

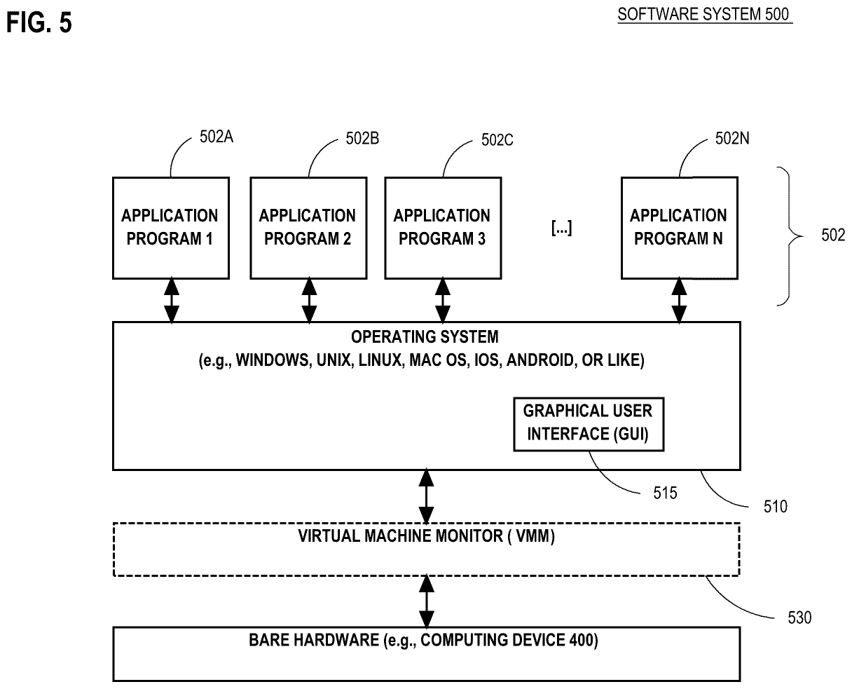

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria are met.

In a software implementation, when a machine learning model is referred to as receiving an input, being executed, and/or generating an output or prediction, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of the best breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures For Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as a sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Fewer neurons means fewer activation values need be computed, and/or fewer derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in a matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that are not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depend on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occur as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
inferring, from an input that contains a value of a feature that has a plurality of multipliers, a probability of a class;
selecting based on the value of the feature in the input, from the plurality of multipliers of the feature, a multiplier that is specific to both of the feature and the value of the feature; and
classifying the input based on a multiplicative product of the probability of the class and the multiplier that is specific to both of the feature and the value of the feature;
wherein the method is performed by one or more computers.

2. The method of claim 1 wherein:
said probability of the class is a first probability of the class;
said multiplier that is specific to both of the feature and the value of the feature is a first value-specific multiplier;
the method further comprises:
inferring, from a second input that contains a second value of the feature, a second probability of the class;
selecting based on the second value of the feature in the second input, from the plurality of multipliers of the feature, a second multiplier that is specific to both of the feature and the second value of the feature;
classifying the second input based on the second multiplier that is specific to both of the feature and the second value of the feature and not based on the first value-specific multiplier.

3. The method of claim 2 further comprising:
inferring, from a third input that contains the second value of the feature, a third probability of the class;
inferring, from a fourth input that contains the second value of the feature, a fourth probability of the class;
detecting, not based on the first probability of the class, a minimum probability for the second value of the feature and a maximum probability for the second value of the feature based on: the second probability of the class, the third probability of the class, and the fourth probability of the class.

4. The method of claim 3 further comprising generating the second multiplier that is specific to both of the feature and the second value of the feature based on the minimum probability for the second value of the feature and the maximum probability for the second value of the feature.

5. The method of claim 4 wherein said generating the second multiplier that is specific to both of the feature and the second value of the feature is based on a first ratio of the minimum probability for the second value of the feature over the maximum probability for the second value of the feature and a second ratio of the maximum probability for the second value of the feature over the minimum probability for the second value of the feature.

6. The method of claim 5 wherein the second multiplier that is specific to both of the feature and the second value of the feature is generated in a range from the first ratio to the second ratio.

7. The method of claim 1 further comprising generating, by a bi-objective optimizer, the plurality of multipliers of the feature.

8. The method of claim 7 further comprising receiving, by the bi-objective optimizer, two validation scores that are based on the plurality of multipliers of the feature.

9. The method of claim 8 wherein the two validation scores that are based on the plurality of multipliers of the feature are a fitness score and a fairness score.

10. The method of claim 1 wherein:
said inferring is performed by a classifier that was trained;
the method further comprises without retraining the classifier:
adjusting the multiplier that is specific to both of the feature and the value of the feature;
reclassifying the input.

11. The method of claim 10 wherein said adjusting and said reclassifying do not use the classifier.

12. The method of claim 1 further comprising:
generating multiple pluralities of multipliers of the feature;
detecting a subset of the multiple pluralities of multipliers of the feature that are on a bi-objective Pareto frontier.

13. The method of claim 1 wherein:
the method further comprises:
inferring, from the input that contains the value of the feature, a second probability of a second class and a third probability of a third class;
rescaling, based on said multiplicative product of the probability of the class and the multiplier that is specific to both of the feature and the value of the feature, the second probability of the second class and the third probability of the third class;
said classifying the input is not based on said rescaling the second probability of the second class and the third probability of the third class.

14. The method of claim 1 wherein:
the multiplier that is specific to both of the feature and the value of the feature is less than one;
said probability of the class is a probability of a first class;
the method further comprises from the input that contains the value of the feature,
inferring a second probability of a second class that is less than the probability of the first class and a third probability of a third class;
said classifying the input comprises classifying the input as the second class.

15. A method comprising:
generating, by a bi-objective optimizer, a first multiplier for a first class of a plurality of mutually exclusive classes and a second multiplier for a second class of the plurality of mutually exclusive classes;
generating, from an input, an inference that contains a probability of the first class and a probability of the second class; and
classifying the input based on:
a first multiplicative product of the probability of the first class and the first multiplier, and
a second multiplicative product of the probability of the second class and the second multiplier;
wherein the method is performed by one or more computers.

16. The method of claim 15 wherein:
said classifying the input uses a plurality of multipliers that contains the first multiplier and the second multiplier;
the inference contains a plurality of probabilities that contains the probability of the first class and the probability of the second class;
a count of the plurality of probabilities equals a count of the plurality of mutually exclusive classes;
a count of the plurality of multipliers is less than the count of the plurality of probabilities.

17. One or more non-transitory computer-readable media storing instructions that, when executed by one or more processors, cause:
inferring, from an input that contains a value of a feature that has a plurality of multipliers, a probability of a class;
selecting based on the value of the feature in the input, from the plurality of multipliers of the feature, a multiplier that is specific to both of the feature and the value of the feature; and
classifying the input based on a multiplicative product of the probability of the class and the multiplier that is specific to both of the feature and the value of the feature.

18. The one or more non-transitory computer-readable media of claim 17 wherein:
said probability of the class is a first probability of the class;
said multiplier that is specific to both of the feature and the value of the feature is a first value-specific multiplier;
the instructions further cause:
inferring, from a second input that contains a second value of the feature, a second probability of the class;
selecting based on the second value of the feature in the second input, from the plurality of multipliers of the feature, a second multiplier that is specific to both of the feature and the second value of the feature;
classifying the second input based on the second multiplier that is specific to both of the feature and the second value of the feature and not based on the first value-specific multiplier.

19. The one or more non-transitory computer-readable media of claim 17 wherein the instructions further cause generating, by a bi-objective optimizer, the plurality of multipliers of the feature.

20. The one or more non-transitory computer-readable media of claim 17 wherein:
said inferring is performed by a classifier that was trained;
the instructions further cause without retraining the classifier:
adjusting the multiplier that is specific to both of the feature and the value of the feature;
reclassifying the input.

21. The one or more non-transitory computer-readable media of claim 17 wherein the instructions further cause:
generating multiple pluralities of multipliers of the feature;
detecting a subset of the multiple pluralities of multipliers of the feature that are on a bi-objective Pareto frontier.

22. The one or more non-transitory computer-readable media of claim 17 wherein:
the multiplier that is specific to both of the feature and the value of the feature is less than one;
said probability of the class is a probability of a first class;
the instructions further cause from the input that contains the value of the feature,
inferring a second probability of a second class that is less than the probability of the first class and a third probability of a third class;
said classifying the input comprises classifying the input as the second class.

23. One or more non-transitory computer-readable media storing instructions that, when executed by one or more processors, cause:
generating, by a bi-objective optimizer, a first multiplier for a first class of a plurality of mutually exclusive classes and a second multiplier for a second class of the plurality of mutually exclusive classes;
generating, from an input, an inference that contains a probability of the first class and a probability of the second class; and
classifying the input based on:
a first multiplicative product of the probability of the first class and the first multiplier, and
a second multiplicative product of the probability of the second class and the second multiplier.
